(19) United States
(12) Patent Application Publication
(10) Pub. No.: US 2018/0357676 A1
(43) Pub. Date: Dec. 13, 2018

(54) Data-Driven Graphical User Interfaces for Social Network Advertising Insights

(71) Applicant: Rise Interactive Media & Analytics, LLC, Chicago, IL (US)

(72) Inventors: Brent Laufenberg, Chicago, IL (US); Jonathon Morris, Chicago, IL (US); Lawrence Fisher, Chicago, IL (US); Michael Thone, Chicago, IL (US); Justin Garvin, Chicago, IL (US)

(21) Appl. No.: 16/002,539

(22) Filed: Jun. 7, 2018

Related U.S. Application Data
(60) Provisional application No. 62/516,886, filed on Jun. 8, 2017.

(51) Int. Cl. G06Q 30/02; G06Q 50/00; G06F 3/0482

(52) U.S. Cl. CPC G06Q 30/0269; G06F 3/0482; G06Q 50/01; G06Q 30/0277

(57) ABSTRACT

An embodiment may involve repeatedly receiving, from one or more social network advertising service devices at which one or more social network advertising campaigns are or have been operated, updates to information related to social network advertisement placement and social network advertisement performance over a previous period of time. The embodiment may involve transmitting, for display on a graphical user interface of a client device, representations of the social network advertisement placement and the social network advertisement performance over the previous period of time. The embodiment may involve receiving, via the selectable graph menu options, a selection of two of the plurality of advertising metrics. The embodiment may involve transmitting, for display on the graphical user interface, data representing values of the selected two metrics over the previous period of time.

### CROSS-REFERENCE TO RELATED APPLICATION

This application claims priority to U.S. Provisional Patent Application No. 62/516,886, filed Jun. 8, 2017, the entire contents of which are incorporated by reference herein.

### BACKGROUND

Social network advertising uses the Internet or other data networks to provide promotional and marketing messages to consumers and/or potential customers. It includes social media advertising, which may include advertisements interlaced in a user's social media content and sponsored social media content. The parties involved include an advertiser, who provides advertisement (ad) copy, a social networking service, who integrates the ads into its online content, and a user, who is presented with the online ads. Another potential participant is an advertising agency, who may help generate the ad copy and communicate with the social networking service.

Unlike traditional print, radio, and television advertising, social network advertising allows hyper-focused targeting of ads to particular users and groups of users. Nevertheless, regardless of targeting, it currently lacks the tools for advertisers and advertising agencies to be able to manage advertising budgets on a granular scale or to determine, in near-real-time, the efficacy of the advertisements placed.

### SUMMARY

The embodiments herein involve, but are not limited to, ways in which social network advertising performance information can be displayed on a graphical user interface so that an advertiser can rapidly determine the effectiveness of one or more social network advertising campaigns. In particular, the computer implementations described hereafter may automatically retrieve social network advertising placement and conversion information from one or more remote networked sources, and provide a graphical user interface that presents this information in a logical and readable fashion. The user can filter the display to focus on information that is relevant to the user's goals.

For instance, the graphical user interface might plot the cost of advertising and conversions for a particular advertising campaign over a time period (e.g., the last month). By way of this display, the user can rapidly determine whether the advertising campaign is performing to expectations. For instance, anomalies or discrepancies may be readily apparent in the display, prompting the user to explore these areas further. The graphical user interfaces may also allow the user to “drill down” into specific data to facilitate this exploration. Thus, the embodiments herein solve technical problems associated with the displaying of relevant keyword performance information on a graphical user interface.

A first example embodiment may involve repeatedly receiving, by a computing device from one or more social network advertising service devices at which one or more social network advertising campaigns are or have been operated, updates to information related to social network advertisement placement and social network advertisement performance over a previous period of time. The social network advertisement placement and social network advertisement performance may be associated with the one or more social network advertising campaigns. The first example embodiment may further involve transmitting, by the computing device for display on a graphical user interface of a client device, representations of the social network advertisement placement and the social network advertisement performance over the previous period of time. Reception of the representations may cause the client device to display the representations on the graphical user interface. The graphical user interface may include selectable graph menu options related to a plurality of advertising metrics derivable from the information. The first example embodiment may further involve receiving, by the computing device via the selectable graph menu options, a selection of two of the plurality of advertising metrics. The first example embodiment may finally involve transmitting, by the computing device for display on the graphical user interface, data representing values of the selected two metrics over the previous period of time. Reception of the data may cause the client device to plot a graph on the graphical user interface indicating the values of the selected two metrics over the previous period of time. The values as shown in the graph for each of the selected two metrics may be normalized to one another.

In a second example embodiment, an article of manufacture may include a non-transitory computer-readable medium, having stored thereon program instructions that, upon execution by a computing device, cause the computing device to perform operations in accordance with the first example embodiment.

In a third example embodiment, a computing device may include at least one processor, as well as data storage and program instructions. The program instructions may be stored in the data storage, and upon execution by the at least one processor, cause the computing device to perform operations in accordance with the first example embodiment.

In a fourth example embodiment, a system may include various means for carrying out each of the operations of the first example embodiment.

These as well as other embodiments, aspects, advantages, and alternatives will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 is a high-level depiction of a client-server computing system, according to an example embodiment.

FIG. 2 illustrates a schematic drawing of a computing device, according to an example embodiment.

FIG. 3 illustrates a schematic drawing of a networked server cluster, according to an example embodiment.

FIG. 4 depicts a social network advertising diagram, according to an example embodiment.

FIG. 5 depicts an advertising agency offering graphical user interfaces that provide information on social network advertising performance, according to an example embodiment.

FIG. 6 depicts an architecture for social network advertising performance tracking, according to an example embodiment.

FIG. 7 depicts social network advertising, according to an example embodiment.

FIG. 8 depicts a social networking advertising insights graphical user interface with a graph and a table, according to an example embodiment.

FIG. 9 depicts a flow chart, according to an example embodiment.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Other embodiments can be utilized, and other changes can be made, without departing from the scope of the subject matter presented herein.

Thus, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### 1. OVERVIEW

Social network services may consist of websites or applications that facilitate a network of social interactions and personal relationships for its users. Social networks may allow users to communicate with each other by sending messages or posting information and comments. Each user of a social network service may have a personal page or profile that is customizable to express interests through social media content. Organizations may also have pages that are separate from users' personal pages. This allows the organizations to post social media content to followers or subscribers. Social media content may include status updates, photo albums, videos, blog posts, and articles. Other types of social media content may exist.

As noted above, social network services may facilitate the offering of specific ads from advertisers to particular users. In some embodiments, the advertiser may submit ads for the social network service to place. The social networks may receive ads and then deliver the ads to users by interlacing the ads with social content or by creating sponsored social media content. The ads may be selected dynamically so that they are likely to be related to the content being viewed, or of interest to users that typically view the content. Alternatively or additionally, when demographic or personal information about a particular user is known, the ads may be targeted to that particular user.

Payment models for this advertising vary. In some models, known as cost-per-mille (CPM), advertisers pay a specific amount for every 1000 ads viewed by users (these views are sometimes called “impressions”). On the other hand, in pay-per-click (PPC) models, the advertiser pays when users click on or select a displayed ad, indicating further interest in the product or service being advertised. Other models include pay-per-performance (PPP) or pay-per-engagement (PPE) advertising, in which the advertiser pays when the user undertakes a particular set of one or more actions. These actions may result in leads for the advertiser, such as users filling out an online form, accessing a particular uniform resource locator (URL), downloading a particular file, watching a particular video, or dialing a particular phone number. These actions may also include conducting an online purchase of a particular product or service.

Regardless of the payment model, the advertiser's payment may be divided, in some fashion, between the content provider serving the ads and the social network service. For instance, the content provider may obtain 70% of each unit of payment, while the social network service obtains the remaining 30%.

Some social network services operate under an auction model for selling advertisement space. Advertisers may select, for instance, keywords or keyphrases with which they would like their ads associated, as well as a bid amount. The social network service then, in turn, displays the ad of a selected bidder (e.g., the highest bidder) in areas of the social network's social media platform that also display content related to the selected bidder's keywords or keyphrases. For example, ads bundled with the keywords “auto,” “automobile,” and “car” may be displayed on a user's social media feed when the user is viewing social media content related to cars and/or driving. In some cases, the social network service may display the ad to a user associated with the selected keywords or keyphrases. The user may have, in the past, expressed interest in these keywords or keyphrases, or is deemed likely to have such an interest. This information may be obtained by parsing a user's search history on the social media platform. Thus, in the case of the above example, if the user is deemed interested in cars, the ads may be displayed to a user via pages and content that are not related to cars and/or driving.

Some social network services may determine interests based on a user's activity on other websites unrelated to the social network. For instance, if a user is browsing a retail website to purchase shoes, the user's internet browser may store cookies or other related information about the retail website in the browser cache. Then, when the user logs into the social network service, the social network service may parse the user's browser cache and cookies to determine what the user may be interested in buying. Based on this information, the social network service may display relevant ads to the user.

The terms “keywords” and “keyphrases” may refer to single words and groups of words, respectively. For sake of convenience, these terms may be used interchangeably herein.

Measuring the effectiveness of social network advertising campaigns can be challenging given the variety of social network services and payment models. An advertiser may wish to distribute its advertising budget across more than one social network service, and/or may wish to use multiple payment models. The effectiveness may be measured in terms of conversions—the number of users who engaged with the ads of the campaign. But several types of conversions exist: impressions, click-throughs, leads, phone calls, comments, shares, views, and purchases. Additional categories of conversions may exist.

Social network services may be able to track the number of impressions and click-throughs for each ad. However, these services might not have the information to determine that a user who viewed an ad later expressed further interest in, or purchased, a related product. Thus, conversion information regarding the effectiveness of social network advertising is currently available only in limited situations.

The embodiments herein support methods, devices, and systems for providing a more complete view of an advertiser's social network placements and conversions. These embodiments collect and aggregate information from one or more social network services to enable near-real-time monitoring of advertising spending and advertising conversions. With this information, advertisers and/or their advertising agencies may be able to make faster, more informed decisions about how to allocate their advertising budgets to ads on different social network services.

Particularly, the embodiments herein describe interactive data-driven graphical user interfaces, possibly in the form of web pages, that allow an advertiser to rapidly compare various types of data related to the performance of social network advertisement. For instance, an advertiser and/or their advertising agency may be able to compare, at a glance, the amount spent on advertising across different social network services over a particular defined time period to conversions as a result of the advertising for that time period. Similarly, with inputs to the graphical user interfaces, these parties may be able to switch to comparing the number of ad impressions over the particular defined time period to the number of conversions for that time period. The graphical user interfaces may visually identify how well the advertising spending or advertising impressions correlate to conversions.

In this way, the parties may be able to rapidly determine the effectiveness of each of their social network advertising campaigns, and whether they should change strategies for any of these campaigns. For instance, the parties may decide to discontinue a campaign with a low conversion rate, and reallocate that budget to a campaign with a higher conversion rate. On the other hand, the parties may decide to increase the advertising budgets for important campaigns with lower than expected conversion rates. In some cases, the display on the graphical user interfaces may identify a discrepancy between two metrics that are expected to be highly correlated (e.g., advertising spending and conversions). Once presented with such a discrepancy, the user may interact with the graphical user interface to determine a possible cause of the discrepancy.

While the embodiments herein are described as providing web-based interfaces, other types of interfaces may be used instead. For instance, any of the web-based interfaces herein may be replaced by interfaces of standalone applications for personal computers, tablets, smartphones, etc. Further, even though online advertising agencies are described throughout this disclosure as placing ads on behalf of advertiser, these agencies are not necessary. Thus, the embodiments herein may be used by advertisers themselves without assistance from an online advertising agency.

Regardless of how they may be implemented, the embodiments herein may make use of one or more computing devices. These computing devices may include, for example, client devices under the control of users, and server devices that directly or indirectly interact with the client devices. Such devices are described in the following section.

### 2. EXAMPLE COMPUTING DEVICES AND CLOUD-BASED COMPUTING ENVIRONMENTS

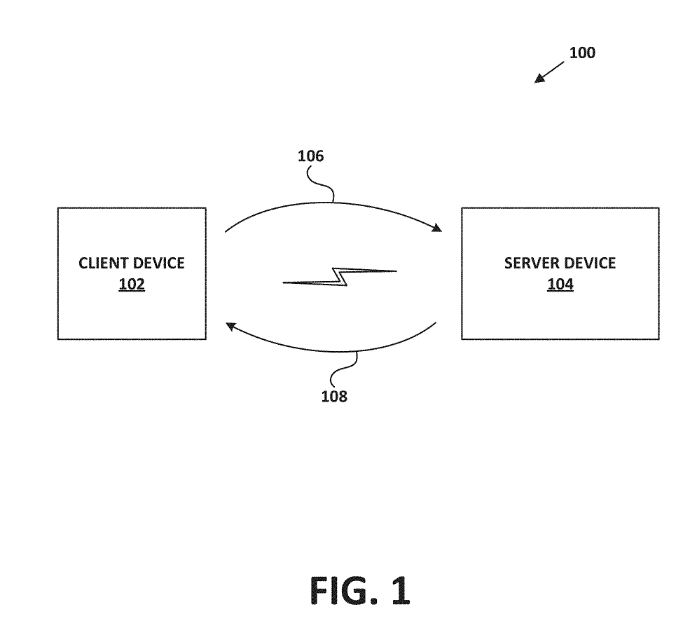

FIG. 1 illustrates an example communication system 100 for carrying out one or more of the embodiments described herein. Communication system 100 may include computing devices. Herein, a “computing device” may refer to either a client device, a server device (e.g., a stand-alone server computer or networked cluster of server equipment), or some other type of computational platform.

Client device 102 may be any type of device including a personal computer, laptop computer, a wearable computing device, a wireless computing device, a head-mountable computing device, a mobile telephone, or tablet computing device, etc., that is configured to transmit data 106 to and/or receive data 108 from a server device 104 in accordance with the embodiments described herein. For example, in FIG. 1, client device 102 may communicate with server device 104 via one or more wireline or wireless interfaces. In some cases, client device 102 and server device 104 may communicate with one another via a local-area network. Alternatively, client device 102 and server device 104 may each reside within a different network, and may communicate via a wide-area network, such as the Internet.

Client device 102 may include a user interface, a communication interface, a main processor, and data storage (e.g., memory). The data storage may contain instructions executable by the main processor for carrying out one or more operations relating to the data sent to, or received from, server device 104. The user interface of client device 102 may include buttons, a touchscreen, a microphone, and/or any other elements for receiving inputs, as well as a speaker, one or more displays, and/or any other elements for communicating outputs.

Server device 104 may be any entity or computing device arranged to carry out the server operations described herein. Further, server device 104 may be configured to send data 108 to and/or receive data 106 from the client device 102.

Data 106 and data 108 may take various forms. For example, data 106 and 108 may represent packets transmitted by client device 102 or server device 104, respectively, as part of one or more communication sessions. Such a communication session may include packets transmitted on a signaling plane (e.g., session setup, management, and teardown messages), and/or packets transmitted on a media plane (e.g., text, graphics, audio, and/or video data).

Regardless of the exact architecture, the operations of client device 102, server device 104, as well as any other operation associated with the architecture of FIG. 1, can be carried out by one or more computing devices. These computing devices may be organized in a standalone fashion, in cloud-based (networked) computing environments, or in other arrangements.

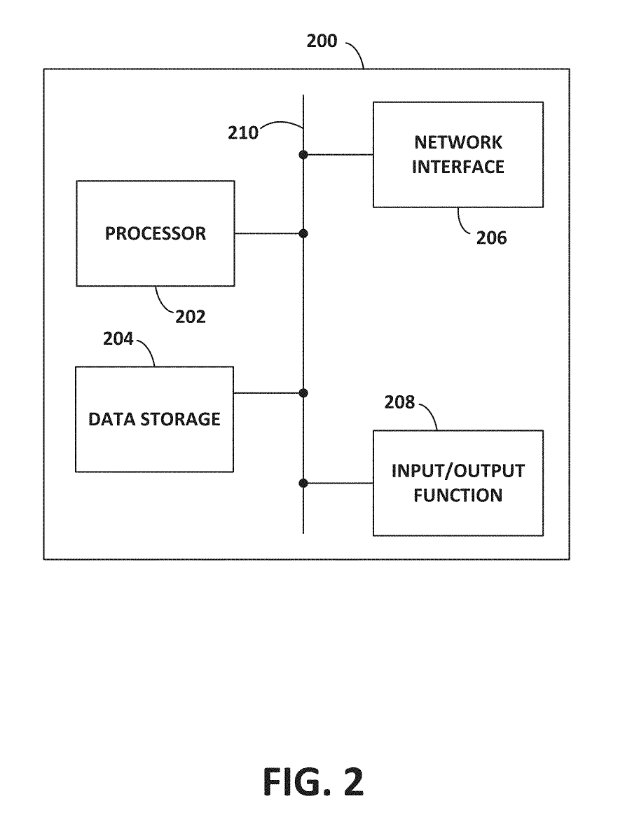

FIG. 2 is a simplified block diagram exemplifying a computing device 200, illustrating some of the functional components that could be included in a computing device arranged to operate in accordance with the embodiments herein. Example computing device 200 could be a client device, a server device, or some other type of computational platform. For purpose of simplicity, this specification may equate computing device 200 to a server from time to time. Nonetheless, the description of computing device 200 could apply to any component used for the purposes described herein.

In this example, computing device 200 includes a processor 202, a data storage 204, a network interface 206, and an input/output function 208, all of which may be coupled by a system bus 210 or a similar mechanism. Processor 202 can include one or more CPUs, such as one or more general purpose processors and/or one or more dedicated processors (e.g., application specific integrated circuits (ASICs), digital signal processors (DSPs), network processors, etc.).

Data storage 204, in turn, may comprise volatile and/or non-volatile data storage and can be integrated in whole or in part with processor 202. Data storage 204 can hold program instructions, executable by processor 202, and data that may be manipulated by these instructions to carry out the various methods, processes, or operations described herein. Alternatively, these methods, processes, or operations can be defined by hardware, firmware, and/or any combination of hardware, firmware and software. By way of example, the data in data storage 204 may contain program instructions, perhaps stored on a non-transitory, computer-readable medium, executable by processor 202 to carry out any of the methods, processes, or operations disclosed in this specification or the accompanying drawings.

Network interface 206 may take the form of a wireline connection, such as an Ethernet, Token Ring, or T-carrier connection. Network interface 206 may also take the form of a wireless connection, such as IEEE 802.11 (Wifi), BLUETOOTH®, or a wide-area wireless connection. However, other forms of physical layer connections and other types of standard or proprietary communication protocols may be used over network interface 206. Furthermore, network interface 206 may comprise multiple physical interfaces.

Input/output function 208 may facilitate user interaction with example computing device 200. Input/output function 208 may comprise multiple types of input devices, such as a keyboard, a mouse, a touch screen, and so on. Similarly, input/output function 208 may comprise multiple types of output devices, such as a screen, monitor, printer, or one or more light emitting diodes (LEDs). Additionally or alternatively, example computing device 200 may support remote access from another device, via network interface 206 or via another interface (not shown), such as a universal serial bus (USB) or high-definition multimedia interface (HDMI) port.

In some embodiments, one or more computing devices may be deployed in a networked architecture. The exact physical location, connectivity, and configuration of the computing devices may be unknown and/or unimportant to client devices. Accordingly, the computing devices may be referred to as “cloud-based” devices that may be housed at various remote locations.

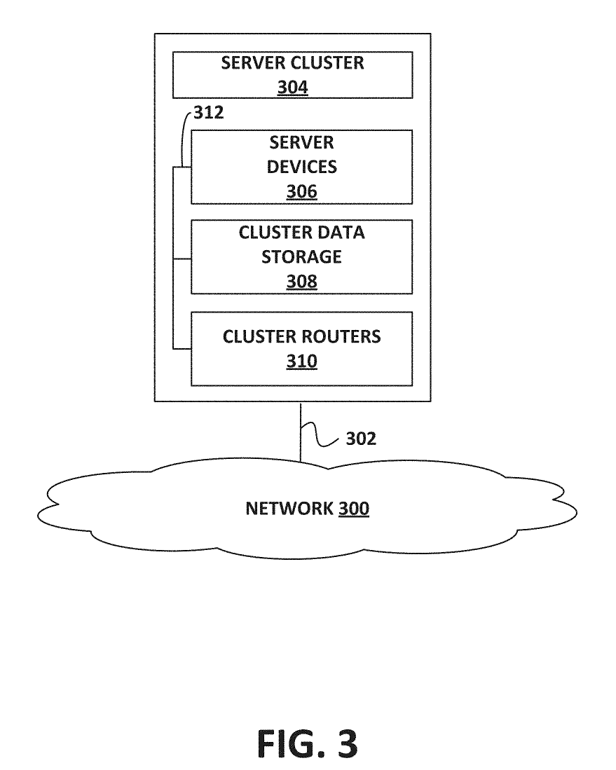

FIG. 3 depicts a cloud-based server cluster 304 in accordance with an example embodiment. In FIG. 3, functions of a server device, such as server device 104 (as exemplified by computing device 200) may be distributed between server devices 306, cluster data storage 308, and cluster routers 310, all of which may be connected by local cluster network 312. The number of server devices, cluster data storages, and cluster routers in server cluster 304 may depend on the computing task(s) and/or applications assigned to server cluster 304.

For example, server devices 306 can be configured to perform various computing tasks of computing device 200. Thus, computing tasks can be distributed among one or more of server devices 306. To the extent that these computing tasks can be performed in parallel, such a distribution of tasks may reduce the total time to complete these tasks and return a result. For purpose of simplicity, both server cluster 304 and individual server devices 306 may be referred to as “a server device.” This nomenclature should be understood to imply that one or more distinct server devices, data storage devices, and cluster routers may be involved in server device operations.

Cluster data storage 308 may be data storage arrays that include disk array controllers configured to manage read and write access to groups of hard disk drives. The disk array controllers, alone or in conjunction with server devices 306, may also be configured to manage backup or redundant copies of the data stored in cluster data storage 308 to protect against disk drive failures or other types of failures that prevent one or more of server devices 306 from accessing units of cluster data storage 308.

Cluster routers 310 may include networking equipment configured to provide internal and external communications for the server clusters. For example, cluster routers 310 may include one or more packet-switching and/or routing devices configured to provide (i) network communications between server devices 306 and cluster data storage 308 via cluster network 312, and/or (ii) network communications between the server cluster 304 and other devices via communication link 302 to network 300.

Additionally, the configuration of cluster routers 310 can be based at least in part on the data communication requirements of server devices 306 and cluster data storage 308, the latency and throughput of the local cluster networks 312, the latency, throughput, and cost of communication link 302, and/or other factors that may contribute to the cost, speed, fault-tolerance, resiliency, efficiency and/or other design goals of the system architecture.

As a possible example, cluster data storage 308 may include any form of database, such as a structured query language (SQL) database. Various types of data structures may store the information in such a database, including but not limited to tables, arrays, lists, trees, and tuples. Furthermore, any databases in cluster data storage 308 may be monolithic or distributed across multiple physical devices.

Server devices 306 may be configured to transmit data to and receive data from cluster data storage 308. This transmission and retrieval may take the form of SQL queries or other types of database queries, and the output of such queries, respectively. Additional text, images, video, and/or audio may be included as well. Furthermore, server devices 306 may organize the received data into web page representations. Such a representation may take the form of a markup language, such as the hypertext markup language (HTML), the extensible markup language (XML), or some other standardized or proprietary format. Moreover, server devices 306 may have the capability of executing various types of computerized scripting languages, such as but not limited to Perl, Python, PHP Hypertext Preprocessor (PHP), Active Server Pages (ASP), JavaScript, and so on. Computer program code written in these languages may facilitate the providing of web pages to client devices, as well as client device interaction with the web pages.

### 3. EXAMPLE SOCIAL NETWORK ADVERTISING ARCHITECTURES AND CONVERSION TRACKING

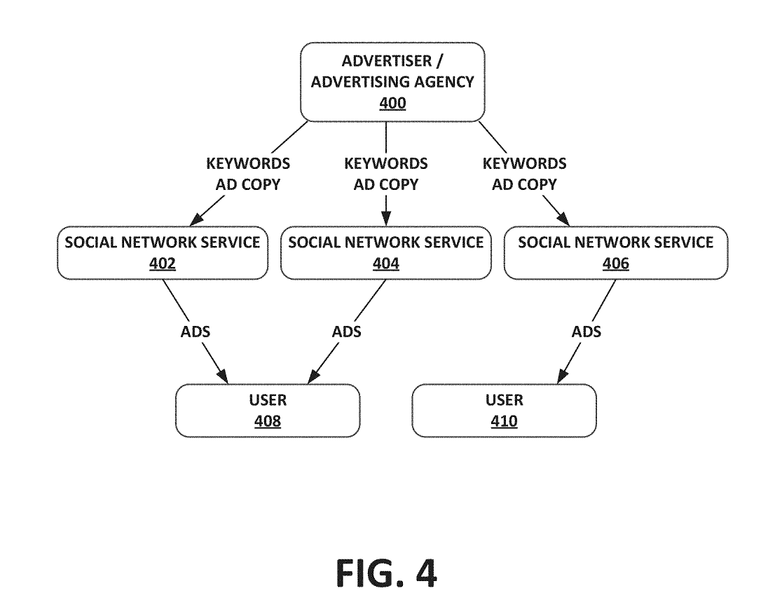

FIG. 4 depicts a social network advertising diagram, according to an example embodiment. In FIG. 4, advertiser/advertising agency 400 may provide keywords and/or ad copy to social network services 402, 404, and 406. The advertiser and the advertising agency may, for example, work together to select the keywords and develop the ad copy. On the other hand, either of these parties may operate independently from the other when selecting the keywords and developing the ad copy. In some embodiments, the advertiser hires the advertising agency to manage the advertiser's online advertising. The advertising agency may also assist the advertiser with other aspects of marketing strategies, branding strategies and/or sales promotions.

Social network services 402, 404, and 406 may be entities that operate social networks that receive keywords and associated ad copy from one or more advertisers and/or advertising agencies, and display the ad copy to users. As shown in FIG. 4, the advertiser/advertising agency 400 may provide one or more ads to social network services 402 and 404 that are viewed by user 408, and one or more ads to social network service 406 that are viewed by user 410. Examples of social network services include FACEBOOK®, INSTAGRAM®, TWITTER®, PINTEREST®, SNAPCHAT®, and LINKEDIN®. Other social network services may exist.

Users 408 and 410 may be individuals accessing the content at social network services 402, 404, and 406. Before, during, and/or after viewing this content, users may view ads. In some cases, users 408 and 410 may be required to view a certain extent of an ad, or view the ad for a certain period of time, before the content is displayed.

Other arrangements with more advertisers, advertising agencies, social network services, and users are possible. In some cases, the number of advertisers and/or users may be in the thousands or millions.

As noted above, the ads provided to a particular social network service may be selected to be related to particular content located on the social network. For instance, if social network service 402 contains pages related to automobiles, social network service 402 may display ad copy associated with the keyword “car” to user 408 when user 408 visits a page relating to automobiles. Alternatively or additionally, the social network service may have access to information regarding a particular user's page visits on its social media platform. Using this information, the social network service may provide ads related to known interests of the particular user. Thus, for instance, if user 408 is known to be interested in automobiles, the social network service may display ad copy associated with the keyword “car” to user 408, even if user 408 is not currently visiting pages related to automobiles.

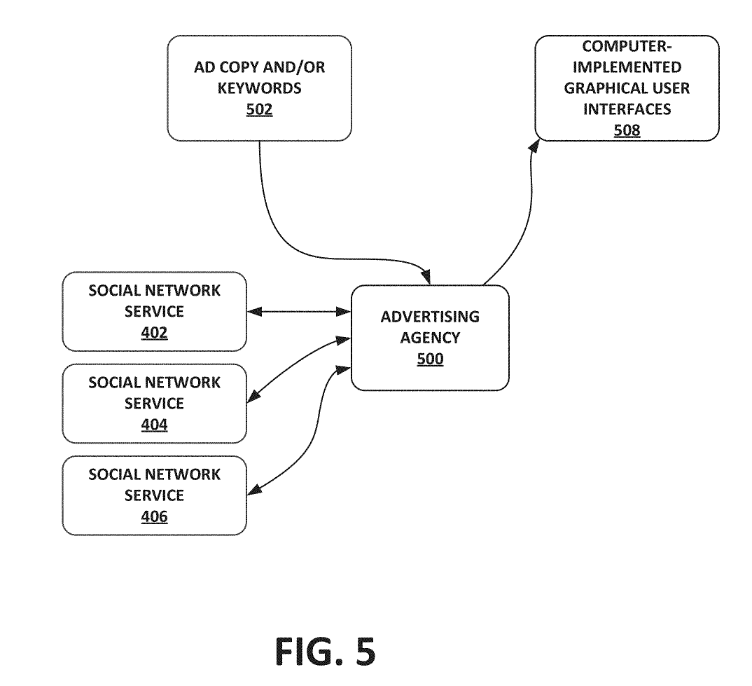

FIG. 5 depicts an advertising agency 500 offering graphical user interfaces that provide information regarding social network advertising performance, according to an example embodiment. Advertising agency 500 may place ads with one or more social network services 402, 404, and 406 on behalf of one or more advertisers.

Each advertiser may provide ad copy and/or keywords 502 to advertising agency 500. Ad copy may include text, graphics, audio, and/or video that make up an online ad. Keywords may include one or more words or phrases that the advertiser seeks to associate with the ad copy. In some cases, the ad copy and/or keywords may be developed by the advertiser, both the advertiser and advertising agency 500, or by advertising agency 500 with little or no input from the advertiser.

Given ad copy and/or keywords 502, advertising agency 500 may place ads with one or more of social network services 402, 404, and 406. As just one example, social network service 402 may be FACEBOOK®, while social network service 404 may be INSTAGRAM® and social network service 406 may be LINKEDIN®. In some cases, the same ad copy and keywords may be used for each service, and in other cases, ad copy and keywords may differ between at least some of these services. Once the ad copy and keywords are provided, social network services 402, 404, and 406 may begin providing ads for display to users.

As noted above, some of social network services 402, 404, and 406 may use a form of auction to determine the price that the advertiser is charged to place its ads. More specifically, the advertiser may bid to have an ad associated with one or more keywords. A social network advertising service then, in turn, displays the ad of a selected bidder on pages or other content that also display (or are otherwise associated with) the selected bidder's keywords. In some cases, the selected bidder may be the one that bid the highest amount. In general, however, other factors may be taken into consideration.

Clearly, advertisers would like to have their ads associated with certain keywords. But they are usually competing with other advertisers for this privilege, and the social network advertising service ultimately decides which ads are associated with which keywords and for how long. In some cases, the social network advertising service may allow multiple ads from the same or different advertisers to be simultaneously associated with the same keywords. For example, FACEBOOK® might integrate two or more ads, in a particular order, when displaying ads relevant to a particular page a user is visiting.

Further, a demand side platform (DSP) may exist between advertising agency 500 and social network services 402, 404, and 406. The DSP may be web-based or client-based software that enables various entities to buy display impressions across multiple social network advertising services in an automated or semi-automated fashion. The DSP may perform analytics to establish the value of an impression, and then place a bid accordingly. DSPs may be operated by third parties other than advertising agency 500 or social network services 402, 404, and 406. Examples of DSPs include those of MEDIAMATH® and Invite Media.

Regardless of how ads are placed, each set of ad copy and associated keywords may be part of a distinct advertising campaign. Some advertising campaigns may include multiple sets of ad copy and associated keywords. In some cases, the same ad copy and/or associated keywords can be used across multiple campaigns and/or multiple advertising accounts. For example, an advertiser may have three main brands, each with its own advertising campaign defined by respective sets of ad copy and associated keywords. However, the advertiser may also advertise its company name, with different ad copy and associated keywords, across all of these brands.

As one or more advertising campaigns are launched and supported in this fashion, advertising agency 500 may determine conversions from social network services 402, 404, and 406 themselves. Advertising agency 500 may determine conversions from information and sales data provided directly by the advertiser. Social network services 402, 404, and 406 may be able to report the number of impressions and click-throughs for a particular ad or advertising campaign, but might not be able to report leads or revenue for the campaign. Thus, advertising agency 500 may use additional traffic tracking services for these purposes. These traffic tracking services may also be included in one or more of social network services 402, 404, and 406 depending on the service's functionality and support.

Traffic tracking services may include various types of analytics services that track and record user traffic. These may include web based analytics (e.g., with or without HTML tracking tags), application (or app) based analytics, phone call based analytics, and so on. Examples of traffic tracking services not located within social network services 402, 404, and 406 may include Google Analytics, Adobe Analytics, and INVOCA® call tracking.

As an example of web based analytics, a traffic tracking service may allow an advertiser to insert a unique tracking code into one or more of the online ads provided to one or more social network services 402, 404, and 406. This tracking code may be a snippet of JavaScript or some other programming language. The tracking code may be silently executed by the user's web browser when the user browses the page(s). The tracking code may collect information about the user (e.g., Internet Protocol (IP) address, and/or information about the user's web browser or computing device) and send this information to a traffic tracking service device located at one or more of social network services 402, 404, and 406. Additionally, the tracking code may set one or more browser cookies in the user's web browser. These cookies may store information such as whether the visitor has been to the site before and the timestamp of the current visit.

As an example of phone based analytics, an advertiser's various advertising campaigns, keywords, web pages, and so on may each be associated with a telephone number. More than one telephone number may be used so that specific advertising campaigns, keywords, web pages can be identified.

For instance, an advertiser may be running two different advertising campaigns, each with a different telephone number (e.g., “vanity” numbers used only for this purpose). In the ad copy for these campaigns, one of these phone numbers may appear. For instance, the ad copy may suggest that a user call the displayed phone number if they are interested in the product or service being advertised. Each phone number may be a specially assigned number that is only used for receiving calls related to the respective ad. Thus, each incoming phone call to a particular tracked phone number can be counted as a conversion. As an example, a traffic tracking service may provide software on a computer that receives the incoming call, identifies the associated campaign, and records this information, perhaps with the caller's phone number. Then, the software may route the call to an agent who answers the call.

Advertising agency 500 may continuously or repeatedly retrieve, from social network services 402, 404, and 406, information regarding the amount spent on advertising as well as the conversions for each advertising campaign. This information may be presented in various ways on computer-implemented graphical user interfaces 508, some of which are described below. Since the amount spent and the conversions per advertising campaign can change minute to minute (or even more frequently), the advertising agency may continuously, periodically, or from time to time, retrieve updated representations of these values. In some cases, the retrieval may take place every 1, 2, 5, 10, 15, 20, 30 or 60 minutes, once per every one or more hours, or randomly. With this updated information, computer-implemented graphical user interfaces 508 may be revised accordingly to reflect the information.

Continuous retrieval of this information may involve a computing device affiliated with advertising agency 500 retrieving the information from social network services 402, 404, and 406 at a particular time. When that retrieval completes, the computing device may initiate another such retrieval. Alternatively, the computing device may wait a period of time (e.g., a few seconds or minutes) before initiating a subsequent retrieval.

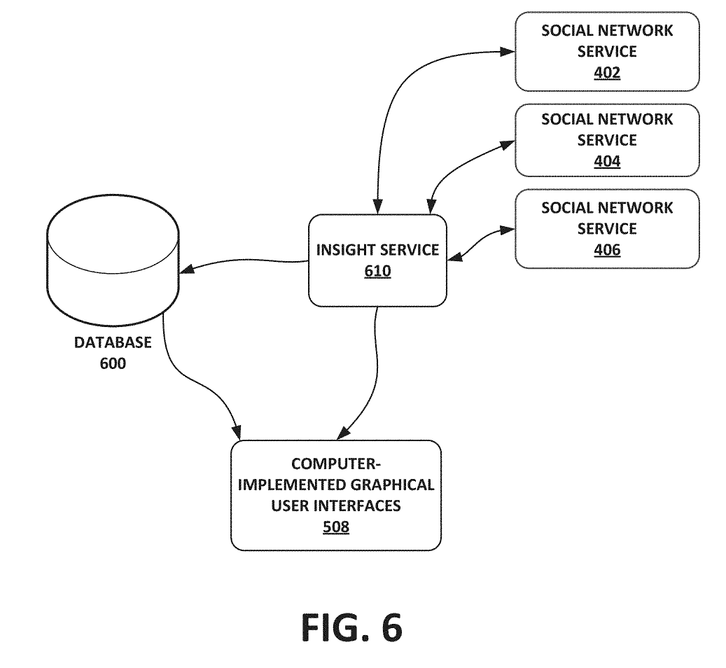

FIG. 6 depicts an architecture for social network advertising performance tracking, according to an example embodiment. FIG. 6 provides another view of the embodiments discussed in the context of FIGS. 4 and 5.

In FIG. 6, social network services 402, 404, and 406 provide traffic tracking information relating to advertising spending and advertising conversions. Insights service 610 may be software that operates on another computing device, and may retrieve the information relating to advertising spending and advertising conversions. Insights service 610 may transmit representations of the information relating to advertising spending and advertising conversions to database 600. Database 600 may store these representations, as well as previously-received representations of the information relating to advertising spending and advertising conversions. Based on the information relating to advertising spending and advertising conversions, and/or other data as well, database 600 and/or insights service 610 may generate computer-implemented graphical user interfaces 508.

### 4. EXAMPLE SOCIAL NETWORK ADVERTISING

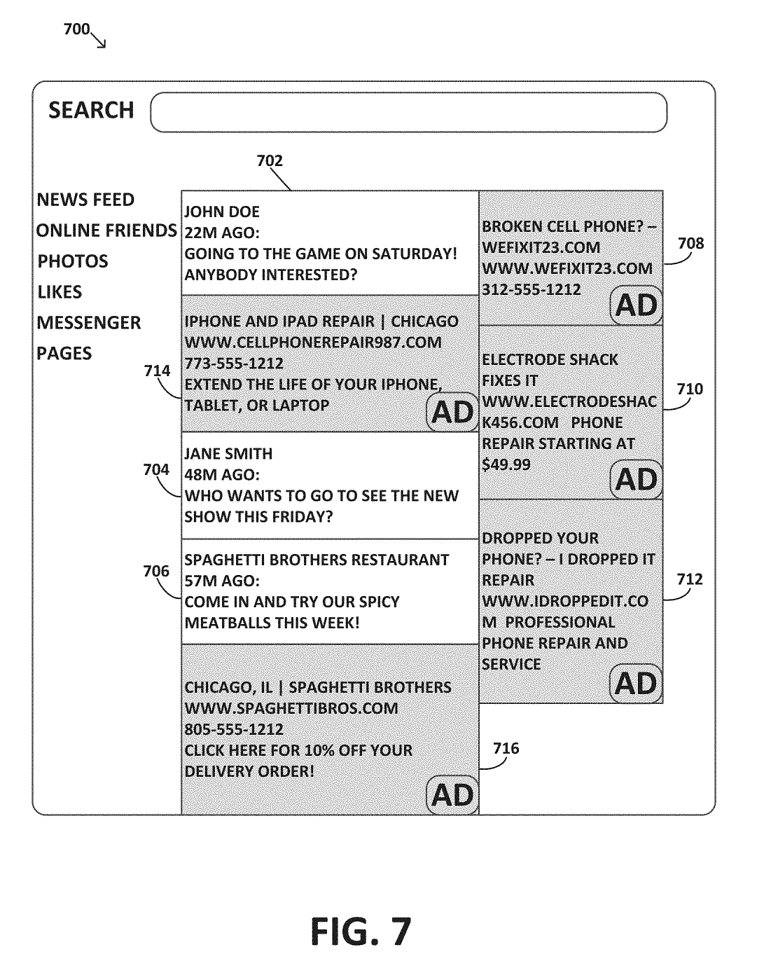

Social network advertising involves an advertiser paying for its ads to appear in users' social media feeds related to one or more keywords. These keywords may be associated with the users' social media history. Payment may be triggered each time such an ad is clicked or displayed. An example of social network advertising is shown in FIG. 7.

This figure features display 700 that includes newsfeed updates 702, 704, and 706, side bar advertisements 708, 710, and 712, and newsfeed advertisements 714 and 716. Display 700 may be one example of a social media user interface, but other types of social media user interfaces may be used as well.

Newsfeed updates 702, 704, and 706 may include social updates for a particular user. These updates may include information relating to the user's friends, contacts, or entities in which the user is interested. For example, newsfeed update 702 includes the string “going to the game on Saturday! Anybody interested?” posted by John Doe 22 minutes prior to the user viewing the newsfeed. In another example, newsfeed updates 702, 704, and 706 may relate to a page in which the user is interested. For example, newsfeed update 706 includes the string “Come in and try our spicy meatballs this week!” posted by Spaghetti Brothers Restaurant 57 minutes prior to the user viewing the newsfeed. Any combination of friend and/or page updates may be included in newsfeed updates 702, 704, and 706.

Side bar advertisements 708, 710, and 712 may include advertisements located on the side bar of the newsfeed of display 700. These advertisements may relate to keywords provided by an advertiser. For example, assume the advertiser operates a cell phone repair business. In this example, the advertiser may have purchased ad space on the side bar of the social network's newsfeed. A user may search for entities or ask friends for a recommendation on the social network that relates to cell phone repair. In response to this activity, the social network service may place the advertiser's advertisement on the side bar of that particular user. This example is represented in display 700 as side bar advertisement 708, which includes the string “Broken cell phone?—WEFIXIT23.COM www.wefixit23.com 312-555-1212.”

Side bar advertisements 708, 710, and 712 may represent one price level of multiple advertisement price levels. For example, advertisements located on the side bar of a particular social media page or website may not be in the user's primary field of view, and thus may be cheaper than advertisements that may be located in the user's primary field of view.

Examples of advertisements that may be located in the user's primary field of view are newsfeed advertisements 714 and 716. These advertisements are interlaced into the social updates of a user's newsfeed, resulting in a higher likelihood of the user viewing or clicking on the advertisement. Using the same example from above, assume the advertiser is interested in and purchases an advertisement that is displayed in a user's primary field of view. In this example, if the user has visited pages on the social media platform that relate to cell phone repair, the social network service may display the advertiser's advertisement as newsfeed advertisements 714 and/or 716. Newsfeed advertisements 714 and 716 may contain the same advertisement information as side bar advertisements 708, 710, and 712, but located in the user's primary field of view. However, newsfeeds advertisements 714 and 716 may contain more information or have corresponding images if the social network service provides a larger advertising area on the newsfeed compared to the area on the side bar.

Side bar advertisements 708, 710, and 712 and newsfeed advertisements 714 and 716 may be selected based on their respective advertisers bidding on one or more of the keywords in or related to the text string “cell phone repair,” or may be selected based on the content in the user's newsfeed. For example, newsfeed advertisement 716 includes the string “Click here for 10% off your delivery order!,” which relates to the information in newsfeed update 706.

The ordering of the advertisements, in which side bar advertisement 708 is displayed higher than side bar advertisement 710, and side bar advertisement 710 is displayed higher than side bar advertisement 712, may also be due to the relationship between the text string and the bid-upon keywords. For instance, the social network service may have selected side bar advertisement 708 to be placed highest in display 700 because the bid for side bar advertisement 708 included the text string “cell phone repair.”

Display 700 may also include graphical ads, banner ads, and other types of information. The representation in FIG. 7 is merely for purpose of example and is not limiting.

### 5. EXAMPLE ADVERTISING METRICS

It is desirable to be able to determine and/or quantify the success of an advertising campaign. This success, however, can be measured in different ways for different campaigns. For instance, in some campaigns, the number of impressions might be the most relevant metric. In other campaigns, conversions might be more important than impressions. For many campaigns, the cost of the campaign, perhaps in units of currency per time period (e.g., dollars per day) is an important factor.

Given this disparity, it is beneficial for the graphical user interfaces disclosed herein to be able to support a wide variety of metrics with which advertising can be evaluated. This section contains descriptions of some such metrics. Nonetheless, other metrics may be used with any of the embodiments herein.

Most of the metrics discussed below can be provided (1) per a particular keyword, (2) per a group of two or more keywords, (3) per a particular advertising campaign, (4) per a group of two or more advertising campaigns, (5) per a particular piece of ad copy, and/or (6) per multiple pieces of ad copy.

A. Cost

Cost may represent advertising spend over a time period. As noted above, cost may be denoted in units of currency per time period. For instance, if $200 is spent on advertising for a campaign on May 16, 2016, the cost, attributed to this campaign, for this day would be $200.

B. Cost Percentage

Cost percentage may represent a portion of the total advertising spend of a time period. For instance, if the $200 is spent on advertising for a campaign on May 16, 2016, and $20 of this amount was spent on the keyword “automobile”, then the cost percentage of this keyword is 10% for the campaign on that day.

C. Impressions

As noted above, impressions may represent the number of times that a particular ad or type of ad was displayed in a time period. For instance, impressions may represent the number of displayed ads for a particular keyword or keywords in the time period, and/or the number of displayed ads for a particular campaign or campaigns in the time period.

D. Clicks

Clicks may represent the number of times that a particular ad or group of ads was clicked on, selected, or otherwise accessed over a time period.

E. Average Cost Per Click (CPC)

Average CPC may represent an average amount that an advertiser pays for a click of its ads over a time period. One way of calculating average CPC is to divide the total advertising spend for the ads in the time period by the number of clicks that those ads receive in the time period.

F. Click-Through Rate (CTR)

CTR may represent a ratio of clicks to impressions for a particular ad or group of ads over a time period. For instance, if an ad has 1000 impressions and 7 clicks in the time period, the CTR is 7/1000 or 0.7%.

G. Conversions

Conversions may represent the number of times over a time period that a viewer of an ad takes an action that the advertiser has defined as valuable. This action might or might not be predicated by the ad being viewed. Any event might be viewed as a conversion, and these events may be tracked by web analytics engines. As noted previously, conversions may include impressions, click-throughs, file downloads, leads, phone calls, and/or purchases.

H. Conversion Rate

Conversion rate may represent an average number of conversions per click during a time period. This value may be a percentage. For instance, if there were 1000 clicks during the time period, 70 of which led to conversions, then the conversion rate for this time period would be 7%.

I. Cost Per Lead (CPL)

CPL may represent an average amount that an online advertiser is charged for a lead generated from one or more of its ads over a time period. CPL may be calculated as amount spent on these ads divided by the number of leads attributable to those ads.

J. Comment Rate

Comment rate may represent the ratio of comments to impressions for a particular ad or group of ads over a time period. For example, if a social network advertising service places advertisements on users' news feeds 100 times and the users only comment twice, then the comment rate may be 2.0%. This may be useful for an advertiser to understand the discussion the advertisement invokes among users.

K. Comments

Comments may represent the number of comments users submit on a particular advertisement. Comments may represent praise or complaints for the advertiser's product, which may be useful to the advertiser when designing new products or updates to the products for which the advertisement relates.

L. Share Rate

Share rate may represent the ratio of shares to impressions for a particular ad or group of ads over a period of time. Shares may occur when a user shares an advertisement on his or her personal newsfeed. For example, if users view an advertisement 10 times but only share it once, then that particular advertisement would have a share rate of 10%.

M. View rate

View rate may represent the ratio of views to impressions for a particular ad or group of ads over a period of time. A view may be registered when an ad is served and actually rendered for display to the user. For example, if an advertisement loads an advertisement on a social media newsfeed, an impression may be registered. However, if the user changes newsfeeds, the advertisement might not be displayed and thus a view might not be recorded. This may be useful for the advertiser because view rate may provide related to the percentage a user actually sees an advertisement.

### 6. EXAMPLE GRAPHICAL USER INTERFACES

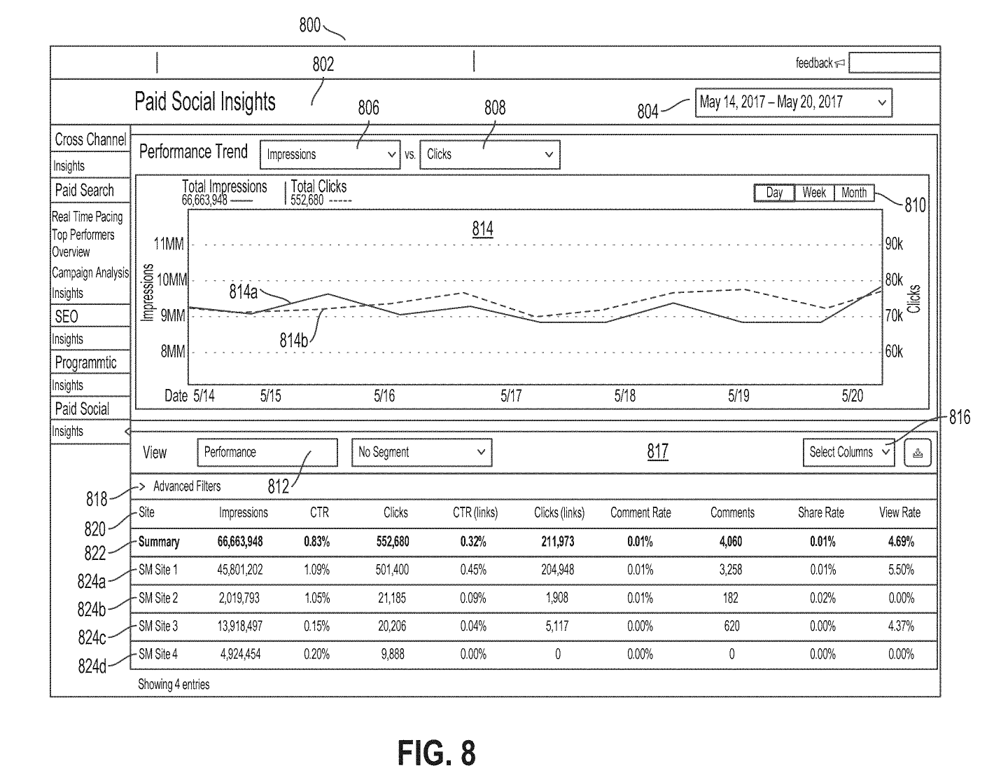

FIG. 8 depicts a graphical user interface, in accordance with example embodiments. Each of these graphical user interfaces may be provided for display on a client device. The information provided therein may be derived, at least in part, from data stored in a database, such as database 600. Nonetheless, this graphical user interfaces is merely for purpose of illustration. The applications described herein may provide a graphical user interface that formats information differently, includes more or less information, and includes different types of information.

One of the difficulties that advertisers and advertising agencies encounter is that it is challenging to be able to measure the performance of social network advertising campaigns at both a high level and low level. While these entities can track advertising spending and conversions, for example, on a weekly or monthly basis, it is hard to know how much spending on advertising, on what days, are actually resulting in conversions. Additionally, advertising performance might vary based on the type of device used to view an ad, as well as the social network service that displays the ad.

As described above, data can be collected for many of the metrics discussed in the previous section. But, an advertiser or advertising agency may be simultaneously managing hundreds or thousands (or even more) of advertising campaigns. Thus, the amount of data may be overwhelming. As a consequence, technical tools are required to be able to filter and process this data so that it can be presented in a manageable fashion on one or more configurable graphical user interfaces. Doing so may provide insights into the efficacy of online advertising performance that would otherwise be unavailable.

As just one example, suppose that an advertiser is running a social network advertising campaign with two different pieces of ad copy. With the embodiments herein, the advertiser would be able to determine which of these two ads results in higher conversions or a lower cost per conversion. Further, if one of the ads exhibits a drop in conversions from week to week, the embodiments herein may be able to help the advertiser determine on which day or days the drop occurred, and why the drop occurs at that time. For instance, the advertiser may be able to determine that the drop is correlated with a social network's peak usage time or a lack of content that relates to the advertiser's chosen keywords. In response to making these observations, the advertiser may take measures to change the time of day the ad is shown or advertise with a social network that has more content related to the advertiser's business. The computerized embodiments herein may suggest one or more of these approaches based on the data collected for the ad.

Notably, the embodiments herein require computer implementation. By its very nature, online advertising is premised on the existence of computers and computer networks. Billions of people around the world, accessing the Internet or private networks in various ways, may be served ads. Tracking the performance of these ads, such as the associated number of impressions, clicks, and conversions, occurs on computers that are connected via networks.

Further, there are no non-computerized analogies for such activities. For instance, there is no way to accurately determine how many people have viewed an ad in a print newspaper, much less reliably determine whether a viewing of that ad resulted in a conversion. Thus, the solutions presented herein a specifically designed to solve technical problems related to online advertising.

Moreover, these solutions may take the form of a graphical user interface that presents information that is filtered and organized so that an advertiser or advertising agency can rapidly determine the status of a large number of online advertising campaigns. This graphical user interface automatically provides intuitive and insightful reports that would not be possible to obtain for traditional methods of advertising.

Non-limiting examples of such a graphical user interface is described below. Nonetheless, this example is made for purpose of illustration, and other graphical user interfaces, and layouts of information therein, may be possible.

FIG. 8 depicts a social network insights graphical user interface 800. Graphical user interface 800 includes a chart 814 above a table 817. Both chart 814 and table 817 provide insight into the performance of social network advertising campaigns for a particular client or entity. In some embodiments, the information displayed on chart 814 and table 817 may be related, e.g., such that selection of an option on one of chart 814 or table 817 impacts the information displayed in both.

As an example, suppose that the chart and table are displaying information at the campaign level. If the user selects an option to display information in the table at the ad group level, the chart may automatically update to plot the associated ad group data. Further, if the user selects an option to display information in the table at the keyword level, the chart may automatically update to plot the associated keyword data.

Graphical user interface 800 includes a header section 802, chart 814, and table 817. Header section 802 includes a date range selector 804. Chart 814 includes metric selector 806, metric selector 808, and chart granularity 810. In various embodiments other information may be displayed on or omitted from a chart of graphical user interface 800, and the displayed information can be arranged differently than depicted in FIG. 8.

Table 817 includes a view selector 812, a column selector 816, advanced filter selector 818, table header row 820, table summary row 822, and table entry rows 824a, 824b, 824c, and 824d. In various embodiments other information may be displayed on or omitted from a table of graphical user interface 800, and the displayed information can be arranged differently than depicted in FIG. 8.

The following subsections provide non-limiting descriptions of each of the components of graphical user interface 800.

A. Date Range

Date range selector 804 may be a drop down menu that allows a user to specify a range of dates for which information is to be displayed on chart 814 and table 817. In FIG. 8, this range of dates is May 14, 2017 to May 20, 2017, and is used to determine the x-axis of chart 814.

To select a date range, a user might, for instance, specify a starting date and an ending date. The user may specify a starting date and an ending date by using the drop down functionality of date range selector 804. In some embodiments, a default date range, such as month-to-date range may be provided. Regardless, upon selection of a date range, social network advertising performance data might only be displayed for time periods within the selected date range.

B. Metrics

Metric selector 806 and metric selector 808 may be drop down menus or other types of selectors that each allow a user to select a metric related to social network advertising. In the embodiment depicted in FIG. 8, metric selector 806 controls the metric used for the left-hand y-axis of chart 814, and metric selector 808 controls the metric used for the right-hand y-axis of chart 814.

For instance, metric selector 806 depicts the metric impressions as selected, and impressions are the units used for the left-hand y-axis of chart 814. Similarly, metric selector 808 depicts the metric clicks as selected, and clicks are the unit used for the right-hand y-axis of chart 814. Other possibilities exist.

In some embodiments, metric selector 806 and metric selector 808 may be configured so that the metric selected for one is not available for selection to the other. For instance, as depicted in FIG. 8, if impressions are the metric selected for metric selector 806, then impressions might not be available for selection by way of metric selector 808.

Each metric selector may display any metric discussed herein, including those described in the previous section. These may include cost, cost percentage, impressions, clicks, average CPC, CTR, conversion, conversion rate, CPL, comments, comment rate, shares, share rate, view rate, and so on. Other metrics are possible.

C. Chart

Chart 814 may display a chart or graph comparing the metric selected using metric selector 806 with the metric selected using metric selector 808. One possible implementation is shown in FIG. 8 where chart 814 is a double y-axis graph. The x-axis of this graph represents the days of the date range selected by date range selector 804. The left y-axis represents impressions, as determined by metric selector 806, and the right y-axis represents clicks, as determined by metric selector 808.

In chart 814, impressions are plotted as line 814a and conversions are plotted as line 814b. Notably, the ranges of one or both the left and right y-axes are normalized so that these lines appear in approximately the same location of chart 814. Such normalization may consider the maximum values of the each data set, and scale the y-axes such that these maximum values appear at approximately the same vertical location on chart 814. Overall this chart indicates that there is a strong correlation between the amount of impressions and the number of corresponding clicks for the specified time period.

D. Chart Granularity

Chart granularity 810 may allow a user to select the amount of time represented by each point on the x-axis of chart 814. For instance, FIG. 8 shows each such point representing one day. However, a granularity of a week or month may be selected instead. In some embodiments, when day is selected, each point on the x-axis of chart 814 may represent a day from the first of the current month until the current day (or until the day before the current day). Alternatively, a particular number of days may be displayed, such as the most recent 30 days.

When week is selected, each point on the x-axis may represent a week from the first week of the current month until the current week (or until the week before the current week). Alternatively, a particular number of weeks may be displayed, such as the most recent 4 weeks. Weeks may be defined to start on Sunday, Monday, or any other day of the week. Further, weeks may be defined to have more or fewer than seven days.

When month is selected, each point on the x-axis may represent a month from the first month of the current year until the current month (or until the month before the current month). Alternatively, a particular number of months may be displayed, such as the most recent 6 months. Any of these ranges may be further limited by the availability of data for the requested time period.

E. Table

Table 817 displays a number of columns and rows. Each column may represent either a way in which social network advertising can be categorized or identified, or may represent advertising performance data. Each row may represent social network services, advertising campaigns, device types, or other organizations of advertising information. It may be possible, by way of graphical user interface 800, to sort the rows in ascending or descending order based on the information displayed in one or more of the columns.

Further, table 817 may allow for custom reporting. In particular, custom groupings of campaigns, based on the campaign names themselves, may be created. For instance, a custom grouping may involve grouping all campaign data for campaigns with the term “life insurance” within the campaign name, or within a particular position in the campaign name.

In some arrangements, columns for impressions, CTR, clicks, comment rate, comments, share rate, and view rate may be included in table 817. Impressions, advertising campaigns, and social network advertising services CTR, clicks, comment rate, comments, share rate, and view rate have been described above.

Note that, in some cases, in addition to view selector 812, a segment selector may be present. The segment selector may allow further differentiation of data displayed in table 817. For instance, when the site view type and device view are active, the segment selector may allow further breakouts of the displayed data by social network or device type.

F. Table Rows

Table header row 820 may represent column headers for each column displayed in table 817.

Table summary row 822 may represent a total of the values represented in the following rows of the table. For instance, the entry of table summary row 822 for the impressions column includes a sum of the per-site impressions of each entry. Similarly, the entry of table summary row for the comments column is a sum of the per-site comments for a given advertisement.

Table entry rows 824a, 824b, 824c, and 824d may represent entries for each column in the table. For instance, in the site column, each of table entry rows 824a, 824b, 824c, and 824d may correspond to a different social media website. Specifically, table entry row 824a specifies that this row relates to Social Media (SM) Site 1. Similarly, table entry row 824b specifies that the row relates to SM Site 2.

G. Views

View selector 812 may be a drop down menu or another type of selector that allows a user to select a particular column and row configuration for display in table 817.

A site view as shown in FIG. 8 may provide one row in table 817 per social network advertising service, each row displaying information regarding the advertising performance of ads using the respective online advertising service. In FIG. 8, site view is selected, and table entry rows 824a, 824b, 824c, and 824d correspond to the various social network advertising services the advertiser is engaged with.

A keyword view (not shown) may provide one row in table 817 per keyword, each row displaying information regarding the advertising performance of that keyword.

A campaign view (not shown) may provide one row in table 817 per advertising campaign, each row displaying information regarding the advertising performance of the respective advertising campaign.

A device view (not shown) may provide one row in table 817 per type of device, each row displaying information regarding the advertising performance of the respective type of device. Devices may be categorized as desktop devices (e.g., PCs and laptops), mobile device (e.g., smartphones), tablet devices, or other devices.

Day, week, and month views (not shown) may provide one row in table 817 per day, week, or month, respectively. Each row may display information regarding the advertising performance across all ads on that particular day, week, or month.

H. Column Selector

Column selector 816 may be a drop down menu or another type of selector that allows a user to select individual columns to display in table 817. Some or all of the columns that appear in this table each may be associated with a metric described in the previous section (e.g., impressions, clicks, and so on). Although not shown, there may be drop down menu that displays a scrollable list of columns with a check box next to each. Columns with a checked check box may be displayed, and columns without a checked check box might not be displayed. The user may be able to check and uncheck these boxes, thus adding columns to and removing columns from table 817.

I. Advanced Filters

Advanced filters 818 may be a drop down menu or another type of selector that allows a user to either select a pre-determined filter term, or to enter a custom filter term. Pre-determined filter terms may include the names of any of the columns discussed herein, for example. Once a filter term is selected and applied, only rows including that filter term may be displayed. Filter terms may include numerical values and numerical operators that can be applied to any numerical data visible in Table 817.

### 7. EXAMPLE OPERATIONS

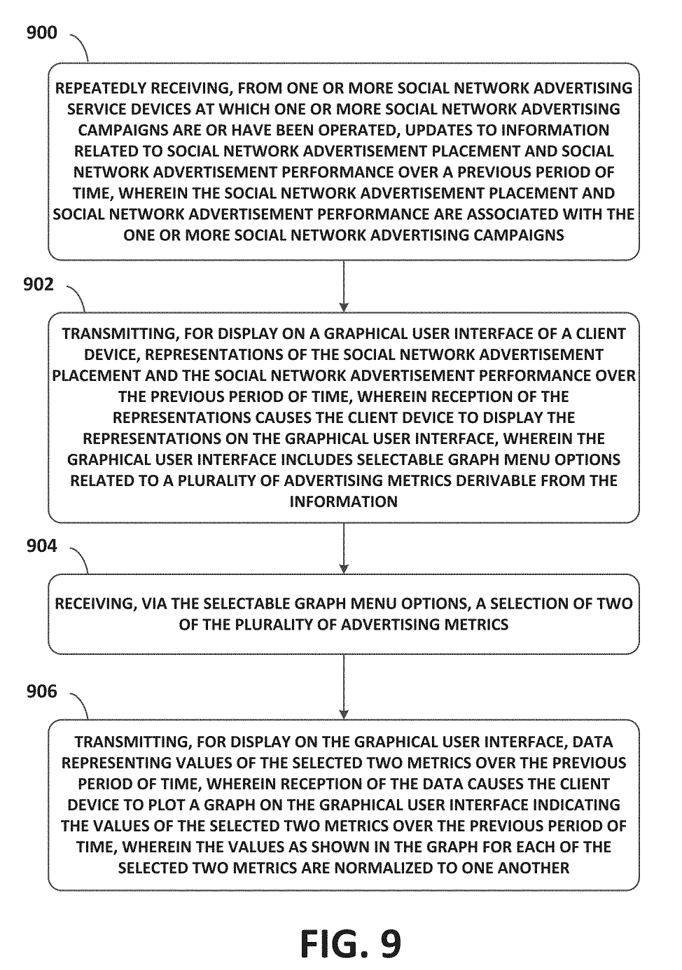

FIG. 9 is a flow chart illustrating an example embodiment. The process illustrated by FIG. 9 may be carried out by a computing device, such as computing device 200, and/or a cluster of computing devices, such as server cluster 304. However, the process can be carried out by other types of devices or device subsystems. For example, the process could be carried out by a portable computer, such as a laptop or a tablet device.

Block 900 may involve repeatedly receiving, by a computing device from one or more social network advertising service devices at which one or more social network advertising campaigns are or have been operated, updates to information related to social network advertisement placement and social network advertisement performance over a previous period of time. The social network advertisement placement and social network advertisement performance may be associated with the one or more social network advertising campaigns.

Block 902 may involve transmitting, by the computing device for display on a graphical user interface of a client device, representations of the social network advertisement placement and the social network advertisement performance over the previous period of time. Reception of the representations may cause the client device to display the representations on the graphical user interface. The graphical user interface may include selectable graph menu options related to a plurality of advertising metrics derivable from the information.

Block 904 may involve receiving, by the computing device via the selectable graph menu options, a selection of two of the plurality of advertising metrics.

Block 906 may involve transmitting, by the computing device for display on the graphical user interface, data representing values of the selected two metrics over the previous period of time. Reception of the data may cause the client device to plot a graph on the graphical user interface indicating the values of the selected two metrics over the previous period of time. The values as shown in the graph for each of the selected two metrics may be normalized to one another.

Some embodiments may further involve receiving a selection of two view options, one defining a type of view, the other defining types of data to be viewed. These embodiments may also involve, based on the selected two view options, determining a subset of the information related to social network advertisement placement and social network advertisement performance. These embodiments may further involve transmitting, by the computing device for display on the graphical user interface, data representing values of the subset of the information over the previous period of time. The reception of the data may cause the client device to display a table indicating the values of the subset of the information over the pre-defined period of time. The columns and rows of the table may be defined by the type of view and the types of data to be viewed.

In some embodiments, the graphical user interface may include a column selection option configured to change the columns of the table as displayed to user-defined selections.

In some embodiments, the graphical user interface may include a filter selection option that, when applied, causes the table to be filtered based on at least one of content of keywords, social network advertising campaign name, or social network service that operates at least one of the one or more social network advertising campaigns.

In some embodiments, the type of view may be a site view and the types of data may be related to social network service advertising. Determining the subset of the information may include determining per-social network service impressions and per-social network service clicks for the one or more social network advertising campaigns. The per-social network service impressions may relate to a total number of impressions for the one or more social network advertising campaigns. The per-social network service clicks may relate to a total number of clicks for the one or more social network advertising campaigns. The columns of the table may include an impressions column and a clicks column containing information related to the per-social network service impressions and per-social network service clicks. The rows of the table may include a social network service name for the one or more social network advertising campaigns.

In some embodiments, the selected two view options are received via selectable view menu options on the graphical user interface.

In some embodiments, the selected two view options may be automatically selected, by the computing device, based on the selected two metrics.

In some embodiments, the previous period of time is a month-to-date period of time.

In some embodiments, the graph includes the previous period of time on an x-axis and each of the values of the selected two metrics on respective y-axes.

In some embodiments, the selected two metrics are selected from a group consisting of impressions, click-through rate, clicks, comment rate, comments, share rate, and view rate. Impressions may be a number of times a particular advertisement was displayed during the one or more social network advertising campaigns over the previous period of time. Click-through rate may be a ratio of clicks to impressions for the particular advertisement over the previous period of time. Clicks may be the number of times the particular advertisement was clicked on, selected, or otherwise accessed over the previous period of time. Comment rate may be a ratio of comments to impressions for the particular advertisement over the previous period of time. Comments may be a number of comments submitted for the particular advertisement over the previous period of time. Share rate may be a ratio of shares to impressions for the particular advertisement over the previous period of time. View rate may be a ratio of views to impressions for the particular advertisement over the previous period of time. Each of the selected two metrics may be related to the one or more social network advertising campaigns.

In some embodiments, the one or more social network advertising campaigns comprises a social network advertising service operating at least one of the social network advertising service devices and placing ads of the one or more social network advertising campaigns into social media pages.

### 8. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, functions described as steps, blocks, transmissions, communications, requests, responses, and/or messages can be executed out of order from that shown or discussed, including substantially concurrently or in reverse order, depending on the functionality involved. Further, more or fewer blocks and/or functions can be used with any of the ladder diagrams, scenarios, and flow charts discussed herein, and these ladder diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods of time. Thus, the computer readable media may include secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
repeatedly receiving, by a computing device from one or more social network advertising service devices at which one or more social network advertising campaigns are or have been operated, updates to information related to social network advertisement placement and social network advertisement performance over a previous period of time, wherein the social network advertisement placement and social network advertisement performance are associated with the one or more social network advertising campaigns;
transmitting, by the computing device for display on a graphical user interface of a client device, representations of the social network advertisement placement and the social network advertisement performance over the previous period of time, wherein reception of the representations causes the client device to display the representations on the graphical user interface, wherein the graphical user interface includes selectable graph menu options related to a plurality of advertising metrics derivable from the information;
receiving, by the computing device via the selectable graph menu options, a selection of two of the plurality of advertising metrics; and
transmitting, by the computing device for display on the graphical user interface, data representing values of the selected two metrics over the previous period of time, wherein reception of the data causes the client device to plot a graph on the graphical user interface indicating the values of the selected two metrics over the previous period of time, wherein the values as shown in the graph for each of the selected two metrics are normalized to one another.

2. The method of claim 1, further comprising:
receiving a selection of two view options, one defining a type of view, the other defining types of data to be viewed;
based on the selected two view options, determining a subset of the information related to social network advertisement placement and social network advertisement performance; and
transmitting, by the computing device for display on the graphical user interface, data representing values of the subset of the information over the previous period of time, wherein reception of the data causes the client device to display a table indicating the values of the subset of the information over the previous period of time, wherein the table comprises columns and rows, and wherein the columns and rows of the table are defined by the type of view and the types of data to be viewed.

3. The method of claim 2, wherein the graphical user interface includes a column selection option configured to change the columns of the table as displayed to user-defined selections.

4. The method claim 2, wherein the graphical user interface includes a filter selection option that, when applied, causes the table to be filtered based on at least one of content of keywords, social network advertising campaign name, or social network service that operates at least one of the one or more social network advertising campaigns.

5. The method of claim 2, wherein the type of view is a site view and the types of data are related to social network service advertising, wherein determining the subset of the information comprises determining per-social network service impressions and per-social network service clicks for the one or more social network advertising campaigns, wherein the per-social network service impressions relate to a total number of impressions for the one or more social network advertising campaigns, wherein the per-social network service clicks relate to a total number of clicks for the one or more social network advertising campaigns, wherein the columns of the table include an impressions column and a clicks column containing information related to the per-social network service impressions and per-social network service clicks, and wherein the rows of the table include a social network service name for the one or more social network advertising campaigns.

6. The method of claim 2, wherein the selected two view options are received via selectable view menu options on the graphical user interface.

7. The method of claim 2, wherein the selected two view options are automatically selected, by the computing device, based on the selected two metrics.

8. The method of claim 1, wherein the previous period of time is a month-to-date period of time.

9. The method of claim 1, wherein the graph includes the previous period of time on an x-axis and each of the values of the selected two metrics on respective y-axes.

10. The method of claim 9, wherein the selected two metrics are selected from a group consisting of impressions, click-through rate, clicks, comment rate, comments, share rate, and view rate, wherein impressions is a number of times a particular advertisement was displayed during the one or more social network advertising campaigns over the previous period of time, wherein click-through rate is a ratio of clicks to impressions for the particular advertisement over the previous period of time, wherein clicks are the number of times the particular advertisement was clicked on, selected, or otherwise accessed over the previous period of time, wherein comment rate is a ratio of comments to impressions for the particular advertisement over the previous period of time, wherein comments are a number of comments submitted for the particular advertisement over the previous period of time, wherein share rate is a ratio of shares to impressions for the particular advertisement over the previous period of time, wherein view rate is a ratio of views to impressions for the particular advertisement over the previous period of time, and wherein each of the selected two metrics are related to the one or more social network advertising campaigns.

11. The method of claim 1, wherein the one or more social network advertising campaigns comprises a social network advertising service operating at least one of the social network advertising service devices and placing ads of the one or more social network advertising campaigns into social media pages.

12. An article of manufacture including a non-transitory computer-readable medium, having stored thereon program instructions that, upon execution by a computing device, cause the computing device to perform operations comprising:
repeatedly receiving, from one or more social network advertising service devices at which one or more social network advertising campaigns are or have been operated, updates to information related to social network advertisement placement and social network advertisement performance over a previous period of time, wherein the social network advertisement placement and social network advertisement performance are associated with the one or more social network advertising campaigns;
transmitting, for display on a graphical user interface of a client device, representations of the social network advertisement placement and the social network advertisement performance over the previous period of time, wherein reception of the representations causes the client device to display the representations on the graphical user interface, wherein the graphical user interface includes selectable graph menu options related to a plurality of advertising metrics derivable from the information;
receiving, via the selectable graph menu options, a selection of two of the plurality of advertising metrics; and
transmitting, for display on the graphical user interface, data representing values of the selected two metrics over the previous period of time, wherein reception of the data causes the client device to plot a graph on the graphical user interface indicating the values of the selected two metrics over the previous period of time, wherein the values as shown in the graph for each of the selected two metrics are normalized to one another.

13. The article of manufacture of claim 12, the operations further comprising:
receiving a selection of two view options, one defining a type of view, the other defining types of data to be viewed;
based on the selected two view options, determining a subset of the information related to social network advertisement placement and social network advertisement performance; and
transmitting, by the computing device for display on the graphical user interface, data representing values of the subset of the information over the previous period of time, wherein reception of the data causes the client device to display a table indicating the values of the subset of the information over the previous period of time, wherein the table comprises columns and rows, and wherein the columns and rows of the table are defined by the type of view and the types of data to be viewed.

14. The article of manufacture of claim 13, wherein the type of view is a site view and the types of data are related to social network service advertising, wherein determining the subset of the information comprises determining per-social network service impressions and per-social network service clicks for the one or more social network advertising campaigns, wherein the per-social network service impressions relate to a total number of impressions for the one or more social network advertising campaigns, wherein the per-social network service clicks relate to a total number of clicks for the one or more social network advertising campaigns, wherein the columns of the table include an impressions column and a clicks column containing information related to the per-social network service impressions and per-social network service clicks, and wherein the rows of the table include a social network service name for the one or more social network advertising campaigns.

15. The article of manufacture of claim 13, wherein the selected two view options are automatically selected, by the computing device, based on the selected two metrics.

16. The article of manufacture of claim 12, wherein the previous period of time is a month-to-date period of time.

17. The article of manufacture of claim 12, wherein the graph includes the previous period of time on an x-axis and each of the values of the selected two metrics on respective y-axes.

18. The article of manufacture of claim 17, wherein the selected two metrics are selected from a group consisting of impressions, click-through rate, clicks, comment rate, comments, share rate, and view rate, wherein impressions is a number of times a particular advertisement was displayed during the one or more social network advertising campaigns over the previous period of time, wherein click-through rate is a ratio of clicks to impressions for the particular advertisement over the previous period of time, wherein clicks are the number of times the particular advertisement was clicked on, selected, or otherwise accessed over the previous period of time, wherein comment rate is a ratio of comments to impressions for the particular advertisement over the previous period of time, wherein comments are a number of comments submitted for the particular advertisement over the previous period of time, wherein share rate is a ratio of shares to impressions for the particular advertisement over the previous period of time, wherein view rate is a ratio of views to impressions for the particular advertisement over the previous period of time, and wherein each of the selected two metrics are related to the one or more social network advertising campaigns.

19. The article of manufacture of claim 12, wherein the one or more social network advertising campaigns comprises a social network advertising service operating at least one of the social network advertising service devices and placing ads of the one or more social network advertising campaigns into social media pages.

20. A computing device comprising:
at least one processor;
memory; and
program instructions, stored in the memory, that upon execution by the at least one processor cause the computing device to perform operations comprising:
repeatedly receiving, from one or more social network advertising service devices at which one or more social network advertising campaigns are or have been operated, updates to information related to social network advertisement placement and social network advertisement performance over a previous period of time, wherein the social network advertisement placement and social network advertisement performance are associated with the one or more social network advertising campaigns;
transmitting, for display on a graphical user interface of a client device, representations of the social network advertisement placement and the social network advertisement performance over the previous period of time, wherein reception of the representations causes the client device to display the representations on the graphical user interface, wherein the graphical user interface includes selectable graph menu options related to a plurality of advertising metrics derivable from the information;
receiving, via the selectable graph menu options, a selection of two of the plurality of advertising metrics; and
transmitting, for display on the graphical user interface, data representing values of the selected two metrics over the previous period of time, wherein reception of the data causes the client device to plot a graph on the graphical user interface indicating the values of the selected two metrics over the previous period of time, wherein the values as shown in the graph for each of the selected two metrics are normalized to one another.
